(19) United States
(12) Patent Application Publication
(10) Pub. No.: US 2025/0018867 A1
(43) Pub. Date: Jan. 16, 2025

(54) MIRROR ROTATION CALIBRATION

(71) Applicant: Gentex Corporation, Zeeland, MI (US)

(72) Inventor: Ingo R. Schwetz, Flein (DE)

(73) Assignee: Gentex Corporation, Zeeland, MI (US)

(21) Appl. No.: 18/433,874

(22) Filed: Feb. 6, 2024

Related U.S. Application Data
(60) Provisional application No. 63/484,045, filed on Feb. 9, 2023.

(51) Int. Cl. B60R 1/31; B60R 1/02; B60R 1/12; G06T 7/521; G06T 7/73; G06V 20/59; H04N 13/204; H04N 23/56; H04N 23/695

(52) U.S. Cl. CPC B60R 1/31; B60R 1/02; B60R 1/1207; G06T 7/521; G06T 7/73; G06V 20/59; H04N 13/204; H04N 23/56; H04N 23/695; B60R 2001/1253; B60R 2001/1284; G06T 2207/10012; G06T 2207/30196; G06T 2207/30244; G06T 2207/30268

(57) ABSTRACT

A monitoring system includes a rearview mirror assembly that has a mounting member and a housing that articulates relative to the mounting member. An imaging device is located in and fixed relative to the housing and is moveable with the housing between a plurality of orientations. The imaging device is configured to capture an image of an occupant's location. A processor is configured to identify at least one landmark in the image and extrapolate a current orientation out of the plurality of orientations of the imaging device based on a position of the at least one landmark in the image.

### CROSS-REFERENCE TO RELATED APPLICATION

This application claims priority to and the benefit under 35 U.S.C. § 119(e) of U.S. Provisional Application No. 63/484,045, filed on Feb. 9, 2023, entitled “MIRROR ROTATION CALIBRATION,” the disclosure of which is hereby incorporated herein by reference in its entirety.

### FIELD OF THE DISCLOSURE

The present disclosure generally relates to a monitoring system, and more particularly to a monitoring system incorporating a structured light with rotation correcting features.

### SUMMARY OF THE DISCLOSURE

According to one aspect of the present disclosure, a monitoring system includes a rearview mirror assembly that has a mounting member and a housing that articulates relative to the mounting member. An imaging device is located in and fixed relative to the housing and is moveable with the housing between a plurality of orientations. The imaging device is configured to capture an image of an occupant's location. A processor is configured to identify at least one landmark in the image and extrapolate a current orientation out of the plurality of orientations of the imaging device based on a position of the at least one landmark in the image.

According to another aspect of the present disclosure, a monitoring system includes a rearview mirror assembly that has a mounting member and a housing that articulates relative to the mounting member. An imaging device is located in and fixed relative to the housing and is moveable with the housing between a plurality of orientations. The imaging device is configured to capture an image of an occupant's location. A processor is configured to identify at least one landmark that is a component of a vehicle containing the rearview mirror assembly in the image and extrapolate a current orientation out of the plurality of orientations of the imaging device based on a position of the at least one landmark in the image.

According to yet another aspect of the present disclosure, a monitoring system includes a rearview mirror assembly that has a mounting member and a housing that articulates relative to the mounting member. An illumination source is configured to emit at least one light spot. A rotation dependent feature is defined by one or both of the at least one light spot and an imprint within an associated vehicle. An imaging device is configured to capture an image of an occupant's location. A processor is configured to identify the rotation dependent feature in the image, and extrapolate a current degree of rotation of the imaging device based on the position of the rotation dependent feature in the image.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side plan view of a vehicle that incorporates a monitoring system in a first construction in accordance with an aspect of the present disclosure;

FIG. 2 is a front plan view of a rearview mirror assembly in accordance with an aspect of the present disclosure;

FIG. 3A is a front view of an image shift as a result of articulating a rearview mirror assembly in a pitch direction in accordance with an aspect of the present disclosure;

FIG. 3B is a front view of an image shift as a result of articulating a rearview mirror assembly in a yaw direction in accordance with an aspect of the present disclosure;

FIG. 3C is a front view of an image shift as a result of articulating a rearview mirror assembly in a roll direction in accordance with an aspect of the present disclosure;

FIG. 4 is a schematic view of a 3D imaging system including a first construction in accordance with an aspect of the present disclosure;

FIG. 5A is an interior view of a vehicle illustrating a light source, imprint, or light spot from a 3D imaging system with a rotation dependent feature in accordance with an aspect of the present disclosure;

FIG. 5B is an interior view of a vehicle illustrating a light source, imprint, or light spot from a 3D imaging system with a rotation dependent feature and an imaging device articulated in a yaw direction in accordance with an aspect of the present disclosure;

FIG. 6 is a schematic view of a 3D imaging system including a second construction in accordance with an aspect of the present disclosure;

FIG. 7 is a schematic view of a 3D imaging system including a third construction in accordance with an aspect of the present disclosure;

FIG. 8 is an interior view of a vehicle illustrating an image with extracted depth in accordance with an aspect of the present disclosure;

FIG. 9 is a schematic view of a 3D imaging system extracting an orientation of an imaging device by triangulating a pair of landmarks in accordance with an aspect of the present disclosure; and

FIG. 10 is a schematic view of a control system that controls functionalities of a monitoring system in accordance with an aspect of the present disclosure.

### DETAILED DESCRIPTION

The present illustrated embodiments reside primarily in combinations of method steps and apparatus components related to a monitoring system incorporating a structured light with rotation correcting features. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

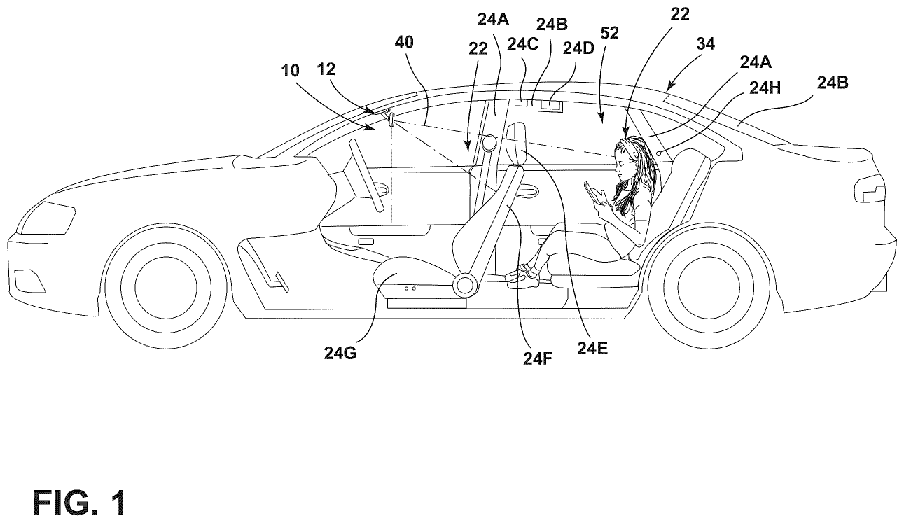

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

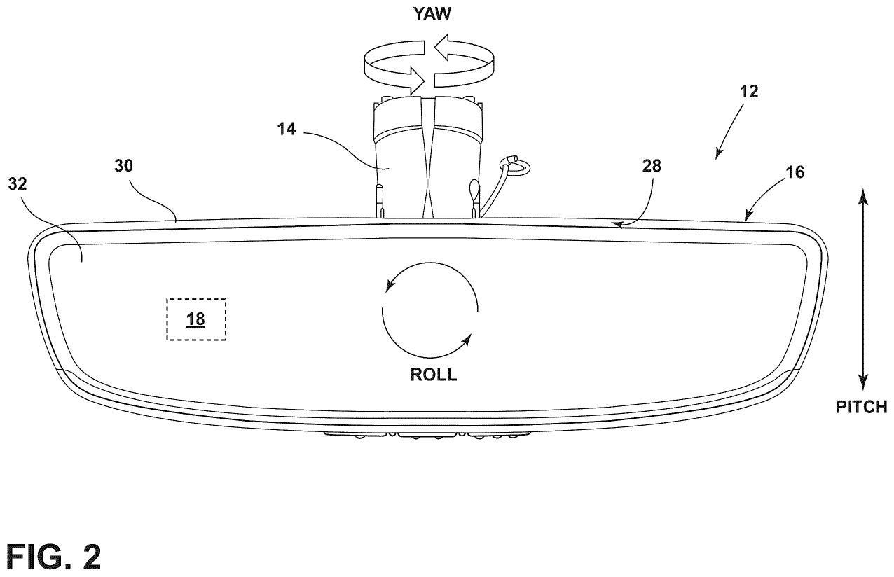

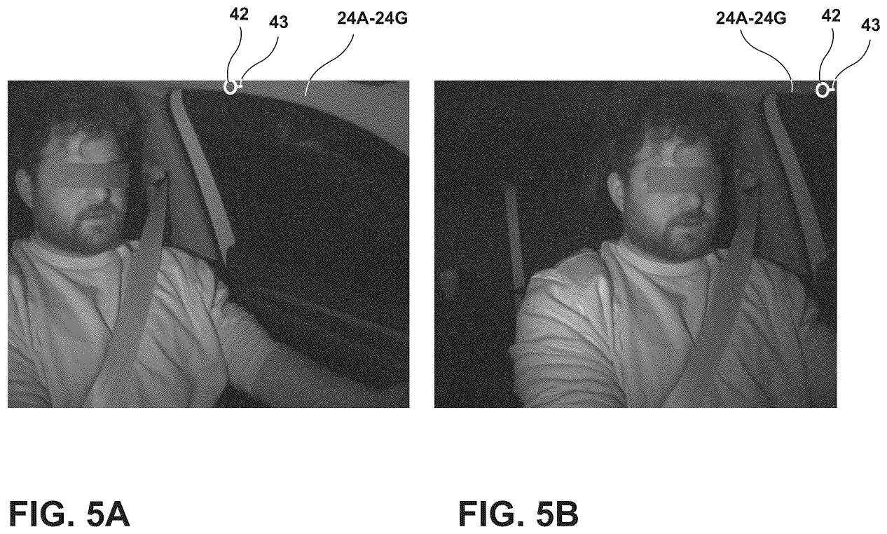

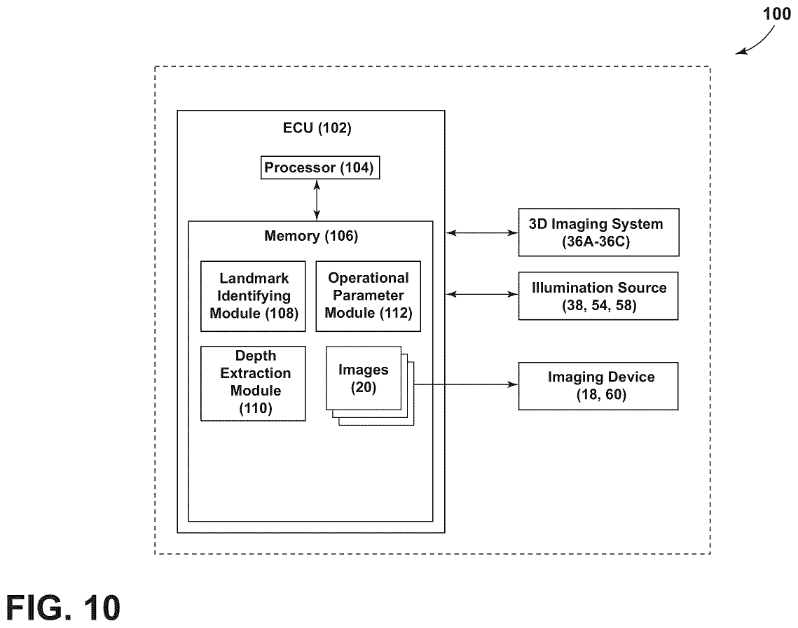

Referring to FIGS. 1-3C and 10, reference numeral 10 generally designates a monitoring system. The monitoring system 10 includes a rearview mirror assembly 12 that has a mounting member 14 and a housing 16 that articulates relative to the mounting member 14 (FIG. 2). An imaging device 18 is located in and fixed relative to the housing 16 and is moveable with the housing 16 between a plurality of orientations. The imaging device 18 is configured to capture an image 20 of an occupant's location 22. A control system 100 (e.g., a processor 104) is configured to identify (FIGS. 5A, 5B, 8 and 9) at least one landmark 24A-24H in the image 20 and extrapolate a current orientation out of the plurality of orientations of the imaging device 18 based on a position of the at least one landmark 24A-24H in the image 20 (FIG. 10).

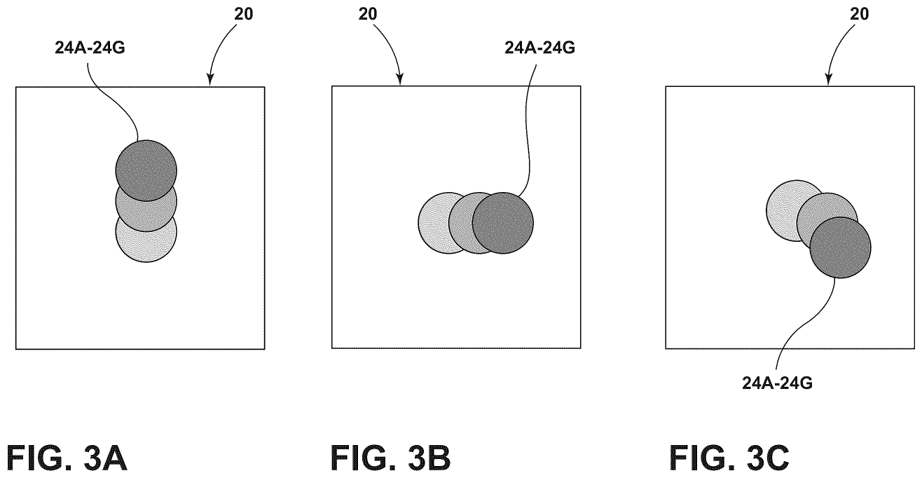

With reference to FIGS. 2-3C, the housing 16 of the rearview mirror assembly 12 includes a rear side and a front side 28 defining a bezel 30. A front substrate 32 may be located in the bezel 30 that defines a viewing area, from which a driver may use the rearview mirror assembly 12 to view conditions of and behind the occupant's location 22. The rearview mirror assembly 12 may include a display and an electrochromic assembly (not shown) that change the transmittance through the viewing area and selectively allow the display to be visible and communicate information to the driver. Because the housing 16 and, by extension, the imaging device 18 articulates relative to the mounting member 14 between the plurality of orientations, the content of two images 20 taken from different orientations can vary. For example, the plurality of orientations may include changes in pitch of the imaging device 18, yaw of the imaging device 18, or roll of the imaging device 18. Each one of these types of movements causes shifting of the content in the image 20. More particularly, changes in pitch of the imaging device 18 cause a vertical shift of the content in the image 20 (FIG. 3A), changes in yaw of the imaging device 18 cause a horizontal shift of the content in the image (FIG. 3B), and changes in the roll of the imaging device 18 cause a rotational shift in either the clockwise or counterclockwise direction (FIG. 3C). By using at least one landmark 24A-24H as a reference point or points, these shifts can be recognized when the control system 100 (e.g., the processor 104) identifies the at least one landmark 24A-24H and extrapolates the current orientation of the imaging device 18.

With reference now back to FIG. 1, the at least one landmark 24A-24H is a component of a vehicle 34 containing the rearview mirror assembly 12. In some embodiments, the component may be fixed, such as one or more of a structural pillar 24A, a rear window 24B, an interior light 24C, or a roof handle 24D, and/or the like. In some embodiments, the component is moveable relative to the vehicle 34, such as one or more of a headrest 24E, a backrest 24F, or a seat cushion 24G. In some embodiments, the landmark 24A-24H may include other components such as an added indicator 24H (e.g., an imprint on a component of the vehicle 34 and/or a light spot 42 with a rotation dependent feature 43) to serve as the landmark 24A-24H. The occupant's location 22 may include a location of a driver and one or more passengers.

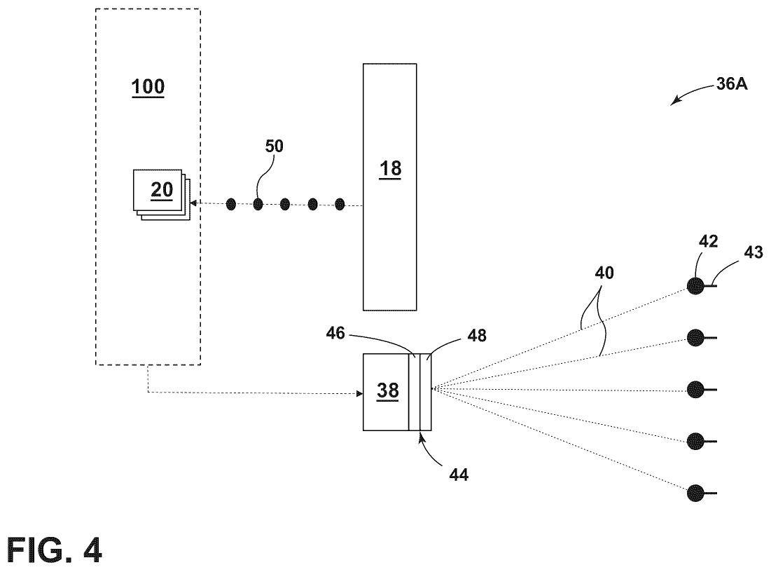

With reference now to FIGS. 4, 6, and 7-9, the monitoring system 10 may further include a three-dimensional (“3D”) imaging system 36A-36C. In some embodiments, the control system 100 (e.g., the processor 104) is further configured to extrapolate a depth of a plurality of the landmarks 24A-24H from the image 20 and determine a plurality of angles, for example, two, three, four, or more angles corresponding to the landmarks 24A-24H. In operation, the plurality of angles may include at least a first angle between the imaging device 18 and one of the landmarks 24A-24H and a second angle between the imaging device and a different one of the landmarks 24A-24H. After the at least first and second angles (e.g., and additional angles) are obtained, the control system 100 (e.g., the processor 104) is further configured to triangulate the current orientation of the imaging device 18 based on the at least first and second angles (e.g., two, three four, or more angles). It should be appreciated that any number of landmarks 24A-24H may be utilized to determine orientation, including a single landmark 24A-24H or a plurality of two or more landmarks 24A-24H (e.g., two or more, three or more, four or more, etc.). When multiple landmarks 24A-24H are utilized, the control system 100 (e.g., the processor 104) may be configured to average or weigh each angle to extrapolate the orientation of the imaging device 18. In some embodiments, the control system 100 (e.g., the processor 104) may be further configured to review two or more images 20 and determine changes of an angle between the landmarks 24A-24H within sequential images 20 to determine movements and/or current orientation of the imaging device 18.

With reference now to FIG. 4, a 3D imaging system 36A is illustrated in accordance with a first construction under the principles of structured light. More particularly, the monitoring system 10 may include one or more illumination sources 38 that are located in a fixed position inside, outside, or a combination of the housing 16 and configured to emit structured light illumination 40 in an infrared spectrum towards the occupant's location 22 and/or the landmark 24A-24H. In some embodiments, the structured light illumination 40 is distributed as a light spot array with a plurality of the light spots 42. Each light spot 42 may define a variety of shapes, such as circles, dots, line segments, or other geometric shapes. Each or select light spots 42 further includes the rotation dependent feature 43, such as a tail, a line, and/or the like, that extends from the geometric shape of the light spot 42. In some embodiments, the orientation of the imaging device 18 may be extrapolated by light shapes in pseudo random patterns or light shapes with imbedded orientation features. In some embodiments, each or select light spots 42 is circular in shape and the rotation dependent feature 43 is a line extending from the circle. In this manner, the rotation dependent feature 43 rotates relative to the imaging device 18 during articulation of the housing 16. The degree of relative rotation of the rotation dependent feature 43 can be extrapolated to determine the current orientation of the imaging device 18 as the housing 16 is articulated. More particularly, changes in the roll of the imaging device 18 cause a relative rotational shift in either the clockwise or counterclockwise direction of the rotation dependent feature 43. As such, the control system 100 (e.g., the processor 104) may be further configured to extrapolate a current degree of rotation of the imaging device 18 based on a position of the rotation dependent feature 43 in the image 20. The extrapolation may include comparing two or more subsequent images 20 or comparing a relative positioning of the rotation dependent feature 43 to the landmark 24A-24H or pixel data within the image 20.

With continued reference to FIG. 4, when the light spot 42 with the rotation dependent feature 43 is employed, the illumination source 38 that projects the light spot 42 may be located outside of the housing 16 such that relative rotation between the imaging device 18 and the light spot 42 can be determined. However, in some embodiments, the illumination source 38 may be located in the housing 16 such that relative rotation between the light spot 42 and at least one landmark 24A-24H can be determined to extrapolate the current orientation of the imaging device 18. Likewise, it should be appreciated that when the control system 100 is configured to identify and utilize the at least one landmark 24A-24H in the image 20 to extrapolate a current orientation of the imaging device 18, the illumination source 38 may be located in the housing 16 such that a relative movement between the light spots 42 and the at least one landmark 24A-24H can be determined. In this manner, the illumination source 38 may be located inside or outside of the housing 16 or, alternatively, two or more illumination sources 38 may be employed that include at least one illumination source 38 in the housing 16 and at least one illumination source 38 outside of the housing 16.

The illumination source 38 may include a least one laser diode (e.g., a plurality of laser diodes) and an optical lens 44. The optical lens 44 may include a collimation element 46 and a diffractive element 48. The collimation element 46 and the diffractive element 48 may be integrally or separately formed. In some embodiments, the imaging device 18 is a camera that captures the image 20 (e.g., out of a plurality of images 20) in a sequence every period of time as designated by reference numeral 50. The periods of time 50 between capturing each of the images 20 may be less than a centisecond, less than 75 milliseconds, between 75 milliseconds and 25 milliseconds, about 50 milliseconds, or less than 50 milliseconds, or any other time frame. In this manner, the imaging device 18 may capture a plurality of the images 20. In some embodiments, two-dimensional (“2D”) information about an interior cabin 52 of the vehicle 34 (e.g., the landmark 24A-24H) may be extracted from the images 20. The control system 100 (e.g., the processor 104) may extrapolate the orientation of the imaging device 18 by a single one of the images 20 or a sequence of a plurality of images 20. In some embodiments, the plurality of images 20 may be utilized to determine a change in orientation of the imaging device 18 over the period of time 50.

With continued reference to FIG. 4, each light spot 42 may have an intensity, luminescence, and/or the like. The distribution of light spots 42 in the spot array pattern may be specifically shaped (e.g., rows and columns, concentric shapes, and/or the like) or non-uniform such as pseudo-random distribution. The spot array pattern conforms to a surface of the landmark 24A-24H where the light spots 42 are reflected back from the surface and captured by the imaging device 18. In some embodiments, the light sources 38 (e.g., laser diodes) are distributed in an array, for example, an array with a rectangular perimeter defined by rows and columns of light sources. In other embodiments, the array of light sources may be distributed in other specifically shaped or non-uniform patterns.

With reference now to FIGS. 4-5B, regardless of the shape and distribution of the light spots 42, when the surface (e.g., an occupant, a landmark 24A-24H, or other locations of the interior cabin 52) reflecting the light spot 42 moves, the light spots 42 also move and this movement is captured by the imaging device 18. Under a first mode of operation, the processor 104 may process the images 20 captured by the imaging device 18 and extrapolate movement of light spots 42 into a depth of the surface based on the principles of triangulation and known geometries between imaging device 18, the illumination source 38, and the distribution of light spots 42. For example, the processor 104 may be configured to determine movement based on an outer perimeter or a center of gravity of each light spot 42. Under the first mode of operation, the imaging device 18 and illumination source 38 need not be closely and rigidly fixed as required in traditional systems because the landmark 24A-24H shifts and the position of the rotation dependent feature 43 can be utilized to determine the orientation of the imaging device 18 relative to the illumination source 38. Based on the known spacing between the imaging device 18 and illumination source 38 (e.g., the laser diodes) and distribution of the light spots 42, the reflected light spot 42 location can be captured along an epipolar line, which, in turn, can be triangulated to extract a depth of the surface. The depth of the surface at each light spot 42 or plurality of light spots 42 can then be used to extrapolate a contour of the surface. Likewise, changes in depth can be used to extrapolate the present location of the surface and movement of the surface as a function of time. In this manner, occupants can be accurately monitored within the interior cabin 52 by calibrating on the basis of the determined pitch, yaw, and roll orientations of the imaging device 18 (FIGS. 5A and 5B).

With continued reference to FIGS. 5A and 5B, the light spot 42 and rotation dependent feature 43 depicted in FIGS. 5A and 5B may alternatively be the previously described added indicator 24H (e.g., imprint). In this manner, the indicator 24H is an imprinted shape, symbol, etc., within the vehicle 34 which may include a feature similar to rotation dependent feature 43. As such, the orientation of the imaging device 18 can be determined based on the relative movement between the imaging device 18 and the indicator 24H obtained in the image 20. As previously described, when the indicator 24H (e.g., imprint) is utilized, the illumination source 38 may be located within housing 16 and move in conjunction with the imaging device 18. It is further contemplated, that the monitoring system 10 may employ both the light spot 42 with the rotation dependent feature 43 and the indicator 24H (e.g., imprint). Such embodiments may employ one, two, or more illumination sources 38.

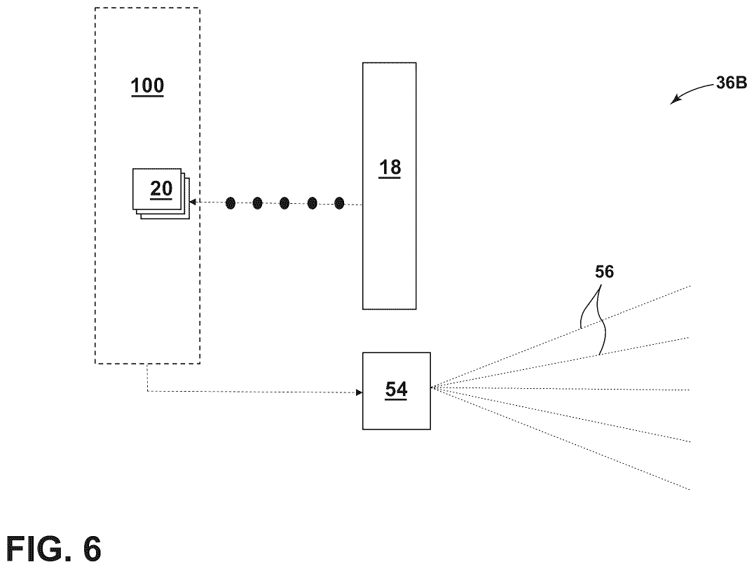

With reference now to FIG. 6, the 3D imaging system 36B that is illustrated in accordance with a second construction may be configured for a second mode of operation under the principles of Time-of-Flight (“ToF”). Unless otherwise explicitly indicated, the 3D imaging system 36B may include all the components, functions, materials, and may be implemented in the same structures of the vehicle 34 as the other constructions. However, the 3D imaging system 36B may include a beam illumination source 54 (e.g., at least one laser diode and/or LED) that is configured to emit a beam illumination 56 (in modulated pulses or continuously emitted). The imaging device 18 in the 3D imaging system 36B may be configured as a sensor. The imaging device 18, therefore, may be configured to capture the beam illumination 56 in the image 20. The control system 100 (e.g., the at least one processor 104) is configured to extract a 2D representation of the landmark 24A-24H, measure a depth of the 2D representation, and extrapolate a 3D representation of the landmark 24A-24H.

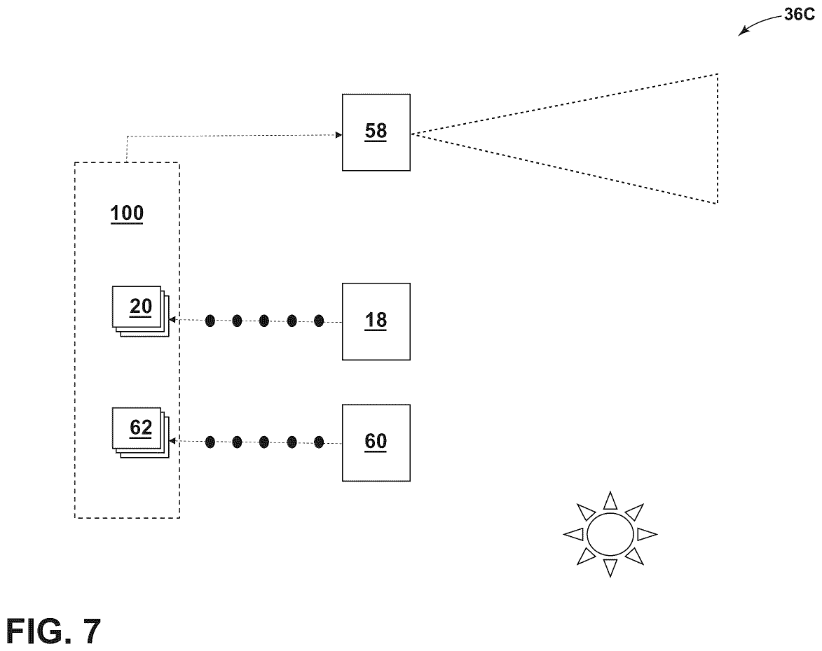

With reference now to FIG. 7, a 3D imaging system 36C of a third construction may be configured for a third mode of operation under the principles of stereo vision. Unless otherwise explicitly indicated, the 3D imaging system 36C may include all the components, functions, materials, and may be implemented in the same structures of the vehicle 34 as the other constructions. However, the 3D imaging system 36C may include a flood illumination source 58 and a reference imaging device 60 used in conjunction with the imaging device 18. More particularly, the imaging device 18 is configured to capture the image 20 and the reference imaging device 60 is configured to capture a reference image 62 that is different from the image 20 in orientation. In this manner, the control system 100 (e.g., the at least one processor 104) may be configured to extract first and second orientations of the 2D representation of the landmark 24A-24H in accordance with the locations in the image 20 and the reference image 62. More particularly, under the third mode of operation, the control system 100 (e.g., the at least one processor 104) may be configured to obtain depth information from the 2D representation by measuring a shift of the landmark 24A-24H along epipolar lines. The depth information may be obtained based on the principles of triangulation and known geometries between the imaging device 18 and the reference imaging device 60 to extrapolate the 3D representation. In this manner, the imaging device 18 and the reference imaging device 60 may capture the image 20 and the reference image 62 simultaneously in a sequence. It should be appreciated that, in some embodiments, the 3D imaging system 36C may not include the flood illumination 58 may be ambient lighting received from an environment.

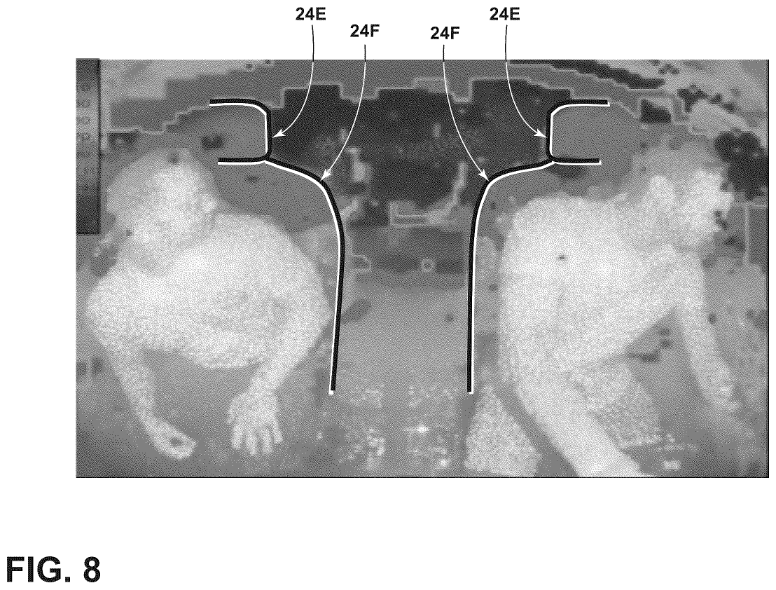

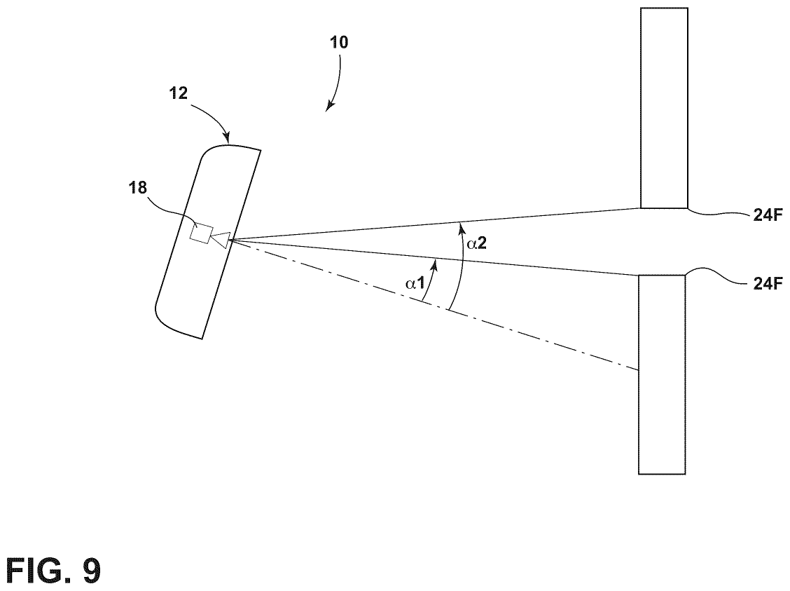

With reference now to FIGS. 8 and 9, the 3D imaging systems 36A-36C are configured to extract a depth of any number of landmarks 24A-24H, for example, at least a first and second landmark 24A-24H (e.g., three, four, or more landmarks). The control system 100 (e.g., the processor 104) is further configured to determine angles associated with the plurality of landmarks 24A-24H, for example, a first angle α₁ between the imaging device 18 and the first landmark 24A-24H and a second angle α₂ between the imaging device and the second landmark 24A-24H. After the first and second angles α₁, α₂ are obtained, the control system 100 (e.g., the processor 104) is further configured to estimate an average or weighted average to determine the current orientation of the imaging device 18 based on the first and second angles α₁, α₂ and depth information. For example, FIG. 8 illustrates identifying the first and second landmarks 24A-24H (e.g., backrests 24F or headrests 24E). FIG. 9 illustrates obtaining the first and second angles α₁, α₂ that are used to estimate the average or weighted average to determine the current orientation of the imaging device 18. The example in FIGS. 8 and 9 are provided as an example only, and it should be appreciated that any number of the at least one landmark 24A-24H and relative angles may be utilized to determine orientation, including a single landmark 24A-24H or a plurality of two, three, four, or more landmarks 24A-24H. When multiple landmarks 24A-24H are utilized, the control system 100 (e.g., the processor 104) may be configured to average or weigh each angle to extrapolate the orientation of the imaging device 18.

With reference now to FIG. 10, the control system 100 of the monitoring system 10 may include at least one electronic control unit (ECU) 102. The at least one ECU 102 may be located in rearview mirror assembly 12 and/or other structures in the vehicle 34. In some embodiments, components of the ECU 102 are located in both the rearview mirror assembly 12 and other structures in the vehicle 34. The at least one ECU 102 may include the processor 104 and a memory 106. The processor 104 may include any suitable processor 104. Additionally, or alternatively, each ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid state) memory, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the monitoring system 10. The imaging device 18, additional imaging device 60, the illumination sources 38, 54, and 58, and the imaging systems 36A-36C may, therefore, be controlled by the control system 100. The memory 106 may, therefore, include a series of captured images 20, a landmark identifying module 108, a depth extraction module 110, and operational parameter module 112.

With reference now to FIGS. 1-10, it should be appreciated that the monitoring system 10 may be incorporated into structures other than the vehicle 34. For example, the monitoring system 10 may be incorporated into aircrafts, buses, rail vehicles, buildings, and/or the like. Generally speaking, the monitoring system 10 may be incorporated into any monitoring system 10 where the imaging device 18 can articulate relative to an environment. In some embodiments, the control system 100 (e.g., the processor 104) may be configured to capture a plurality of the images 20 and perform the orientation identifying steps herein only when a shift is identified between two or more subsequent images 20. In some embodiments, articulation of the imaging device 18 may be sensed via a sensor (not shown) that initiates the orientation identifying steps herein. In some embodiments, identifying the shift between subsequent images 20 includes overlaying the images and noting a difference in location of features (e.g., landmarks 24A-24H). In some embodiments, identifying the shift between subsequent images 20 includes comparing subsequent images 20 and a location of the landmarks 24A-24H with respect to an outer perimeter of the images 20.

The disclosure herein is further summarized in the following paragraphs and is further characterized by combinations of any and all of the various aspects described therein.

According to one aspect of the present disclosure, a monitoring system includes a rearview mirror assembly that has a mounting member and a housing that articulates relative to the mounting member. An imaging device is located in and fixed relative to the housing and is moveable with the housing between a plurality of orientations. The imaging device is configured to capture an image of an occupant's location. A processor is configured to identify at least one landmark in the image and extrapolate a current orientation out of the plurality of orientations of the imaging device based on a position of the at least one landmark in the image.

According to another aspect of the disclosure, an at least one landmark is a component of a vehicle containing a rearview mirror assembly.

According to yet another aspect of the disclosure, the component is fixed relative to a vehicle and includes at least one of a structural pillar, a rear window, an interior light, or a roof handle, other structures, components, imprints, or lighting features specifically added.

According to still another aspect of the disclosure, the component is moveable relative to a vehicle and includes at least one of a headrest, a backrest, or a seat cushion.

According to another aspect of the disclosure, an illumination source is configured to emit structured light illumination in an infrared spectrum towards an at least one landmark.

According to yet another aspect of the disclosure, the structured light illumination includes a light spot reflected from an occupant's location and captured by an imaging device.

According to still another aspect of the disclosure, a rotation dependent feature is defined by at least one of the one or more light spots or an imprint within an associated vehicle.

According to another aspect of the disclosure, a processor is further configured to identify a rotation dependent feature in an image and extrapolate a current degree of rotation of an imaging device based on a position of the rotation dependent feature in an image.

According to yet another aspect of the disclosure, a monitoring system includes a three-dimensional imaging system including at least one of structured light, Time-of-Flight (“ToF”), or stereo vision aligned with the imaging device.

According to still another aspect of the disclosure, at least one landmark includes a plurality of landmarks and a processor is further configured to extrapolate a depth of the plurality of landmarks from the image, determine an angle between the imaging device and the plurality of landmarks, and average or weigh each angle to determine the current orientation of the imaging device relative to the plurality of landmarks.

According to another aspect of the present disclosure, a monitoring system includes a rearview mirror assembly that has a mounting member and a housing that articulates relative to the mounting member. An imaging device is located in and fixed relative to the housing and is moveable with the housing between a plurality of orientations. The imaging device is configured to capture an image of an occupant's location. A processor is configured to identify at least one landmark that is a component of a vehicle containing the rearview mirror assembly in the image and extrapolate a current orientation out of the plurality of orientations of the imaging device based on a position of the at least one landmark in the image.

According to another aspect of the disclosure, the component is fixed relative to a vehicle and includes at least one of a structural pillar, a rear window, an interior light, or a roof handle.

According to still another aspect of the disclosure, the component is an imprint or lighting feature added specifically as landmark.

According to yet another aspect of the disclosure, the component is moveable relative to the vehicle and includes at least one of a headrest, a backrest, or a seat cushion.

According to another aspect of the disclosure, an illumination source is configured to emit structured light illumination in an infrared spectrum towards an occupant's location.

According to still another aspect of the disclosure, a structured light illumination includes a light spot reflected from at least one landmark and captured by the imaging device.

According to yet another aspect of the disclosure, a rotation dependent feature is defined by at least one of the one or more light spots or an imprint within an associated vehicle and a processor is configured to identify the rotation dependent feature in the image and extrapolate a current degree of rotation of the imaging device based on the position of the rotation dependent feature in the image.

According to yet another aspect of the present disclosure, a monitoring system includes a rearview mirror assembly that has a mounting member and a housing that articulates relative to the mounting member. An illumination source is configured to emit at least one light spot. A rotation dependent feature is defined by one or both of the at least one light spot and an imprint within an associated vehicle. An imaging device is configured to capture an image of an occupant's location. A processor is configured to identify the rotation dependent feature in the image, and extrapolate a current degree of rotation of the imaging device based on the position of the rotation dependent feature in the image.

According to another aspect of the disclosure, a processor is configured to identify at least one landmark in the image and extrapolate a current orientation out of the plurality of orientations of the imaging device based on a position of the at least one landmark in the image.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A monitoring system comprising:
a rearview mirror assembly including a mounting member and a housing that articulates relative to the mounting member;
an imaging device located in and fixed relative to the housing and moveable with the housing between a plurality of orientations, the imaging device configured to capture an image of an occupant's location; and
a processor configured to identify at least one landmark in the image and extrapolate a current orientation out of the plurality of orientations of the imaging device based on a position of the at least one landmark in the image.

2. The monitoring system of claim 1, wherein the at least one landmark is a component of a vehicle containing the rearview mirror assembly.

3. The monitoring system of claim 2, wherein the component is fixed relative to the vehicle and includes at least one of a structural pillar, a rear window, an interior light, a roof handle, other structures, components, an imprint, or lighting features specifically added.

4. The monitoring system of claim 2, wherein the component is moveable relative to the vehicle and includes at least one of a headrest, a backrest, or a seat cushion.

5. The monitoring system of claim 1, further including an illumination source is configured to emit structured light illumination in an infrared spectrum towards the occupant's location.

6. The monitoring system of claim 5, wherein the structured light illumination includes one or more light spots reflected from the at least one landmark and captured by the imaging device.

7. The monitoring system of claim 3, wherein a rotation dependent feature is defined by at least one of one or more light spots projected by the illumination source or the imprint.

8. The monitoring system of claim 7, wherein the processor is further configured to:
identify the rotation dependent feature in the image; and
extrapolate a current degree of rotation of the imaging device based on the position of the rotation dependent feature in the image.

9. The monitoring system of claim 1, including a three-dimensional imaging system including at least one of structured light, Time-of-Flight (“ToF”), or stereo vision aligned with the imaging device.

10. The monitoring system of claim 9, wherein the at least one landmark includes a plurality of landmarks and the processor is further configured to:
extrapolate a depth of the plurality of landmarks from the image;
determine an angle between the imaging device and the plurality of landmarks; and
average or weigh each angle to determine the current orientation of the imaging device relative to the plurality of landmarks.

11. A monitoring system comprising:
a rearview mirror assembly including a mounting member and a housing that articulates relative to the mounting member;
an imaging device located in and fixed relative to the housing and moveable with the housing between a plurality of orientations, the imaging device configured to capture an image of an occupant's location; and
a processor configured to identify at least one landmark that is a component of a vehicle containing the rearview mirror assembly in the image and extrapolate a current orientation out of the plurality of orientations of the imaging device based on a position of the at least one landmark in the image.

12. The monitoring system of claim 11, wherein the component is fixed relative to the vehicle and includes at least one of a structural pillar, a rear window, an interior light, or a roof handle.

13. The monitoring system of claim 11, wherein the component is an imprint or lighting feature added specifically as landmark.

14. The monitoring system of claim 11, wherein the component is moveable relative to the vehicle and includes at least one of a headrest, a backrest, or a seat cushion.

15. The monitoring system of claim 11, wherein an illumination source is configured to emit structured light illumination.

16. The monitoring system of claim 15, wherein the structured light illumination is in an infrared spectrum towards the occupant's location.

17. The monitoring system of claim 15, wherein the structured light illumination includes a one or more light spots reflected from the at least one landmark and captured by the imaging device.

18. The monitoring system of claim 13, wherein a rotation dependent feature is defined by one or more light spots projected by the illumination source or the imprint and the processor is further configured to:
identify the rotation dependent feature in the image; and
extrapolate a current degree of rotation of the imaging device based on the position of the rotation dependent feature in the image.

19. A monitoring system comprising:
a rearview mirror assembly including a mounting member and a housing that articulates relative to the mounting member;
an illumination source is configured to emit at least one light spot;
a rotation dependent feature is defined by one or both of the at least one light spot and an imprint within an associated vehicle;
an imaging device configured to capture an image of the occupant's location; and
a processor configured to:
identify the rotation dependent feature in the image; and
extrapolate a current degree of rotation of the imaging device based on the position of the rotation dependent feature in the image.

20. The monitoring system of claim 19, wherein the processor is further configured to identify at least one landmark in the image and extrapolate a current orientation out of the plurality of orientations of the imaging device based on a position of the at least one landmark in the image.
